(19) United States
(12) Patent Application Publication
(10) Pub. No.: US 2004/0225995 A1
(43) Pub. Date: Nov. 11, 2004

(54) Reusable software controls

(76) Inventors: Kyle Marvin, Kingwood, TX (US); David Read, Bellevue, WA (US); David Bau, Gladwyne, PA (US)

Correspondence Address: FLIESLER MEYER, LLP, FOUR EMBARCADERO CENTER, SUITE 400, SAN FRANCISCO, CA, 94111, US

(21) Appl. No.: 10/780,466

(22) Filed: Feb. 17, 2004

Related U.S. Application Data
(60) Provisional application No. 60/451,352, filed on Feb. 28, 2003.

(51) Int. Cl. G06F 9/44

(52) U.S. Cl. 717/100; 717/120

(57) ABSTRACT

A method and system for providing a reusable software control, comprising incorporating the control into an Integrated Development Environment (IDE), wherein a graphical representation of the control can be interactively manipulated, exposing services associated with the control and related to programmatically interacting with a portal, and wherein the control has a customizable interface.

### CLAIM OF PRIORITY

This application claims priority from the following application, which is hereby incorporated by reference in its entirety:

SYSTEMS AND METHODS FOR AN EXTENSIBLE CONTROLS ENVIRONMENT, U.S. application Ser. No. 60/451,352; Inventors: Kyle Marvin et al.; filed on Feb. 28, 2003. (Attorney's Docket No.: BEAS-01444US0)

### CROSS-REFERENCE TO RELATED APPLICATIONS

This application is related to the following co-pending applications which are each hereby incorporated by reference in their entirety:

AN EXTENSIBLE INTERACTIVE DEVELOPMENT ENVIRONMENT, U.S. application Ser. No. 60/451,340; Inventors: Ross Bunker et al.; filed on Feb. 28, 2003. (Attorney's Docket No. BEAS-01437US0)

SYSTEMS AND METHODS FOR A COMMON RUNTIME CONTAINER FRAMEWORK; U.S. application Ser. No. 60/451,012; Inventor: Kyle Marvin; filed on Feb. 28, 2003. (Attorney's Docket No. BEAS-01399US0)

SYSTEM AND METHOD FOR STRUCTURING DISTRIBUTED APPLICATIONS; U.S. application Ser. No. 60/450,226; Inventors: Daryl Olander et al.; filed on Feb. 25, 2003. (Attorney's Docket No. BEAS-01402US0)

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present invention disclosure generally relates to reusable software components, and in particular, reusable software components incorporated into an Integrated Development Environment.

### BACKGROUND

Some interactive development environments (IDEs) allow programmers to develop software with/reusable software components (or controls) often strike a compromise between the level of visual and semantic integration between the control and the IDE, and the extent to which a control can be customized by a programmer. Controls which are fully integrated into an IDE may not be fully customizable. Likewise, controls which are fully customizable may not be completely integrated into an IDE. Furthermore, typically IDEs may not fully support a web application programming paradigm. A more robust control framework is needed to address these deficiencies.

### BRIEF DESCRIPTION OF THE DRAWINGS

FIG. 1 is a illustration of an exemplary graphical representation of a control in an embodiment of the invention.

FIG. 2 is an exemplary Java control source (JCS) file in an embodiment of the invention.

FIG. 3 is an exemplary control property definition file in an embodiment of the invention.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

An integrated development environment (IDE), such as WebLogic® Workshop (available from BEA Systems, Inc.), can provide controls (e.g., Java® controls) that make it easy for users to encapsulate business logic and to access enterprise resources such as databases, legacy applications, and web services. In one embodiment, there can be three different types of Controls: built-in Controls, portal controls, and custom Controls.

Built-in controls provide easy access to enterprise resources. By way of a non-limiting example, a database control makes it easy to connect to a database and perform operations on the data using simple SQL statements, whereas an EJB control enables users to easily access an EJB. Built-in controls provide simple properties and methods for customizing their behavior, and in many cases users can add methods and callbacks to further customize the control. In one embodiment, a portal control is a kind of built-in Java control specific to the portal environment. If users are building a portal, users can use portal controls to expose tracking and personalization functions in multi-page portlets.

In one embodiment, users can also build a custom control from scratch. Custom controls are especially powerful when used to encapsulate business logic in reusable components. It can act as the nerve center of a piece of functionality, implementing the desired overall behavior and delegating subtasks to built-in Controls (and/or other custom controls). This use of a custom Java control ensures modularity and encapsulation. Web services, JSP pages, or other custom Controls can simply use the custom Java control to obtain the desired functionality, and changes that may become necessary can be implemented in one software component instead of many.

In one embodiment, controls are reusable components that can be used anywhere within an application. Users can use built-in controls provided with the IDE, or can create their own. In one embodiment, a framework that supports controls is flexible, supporting a wide variety of uses for controls. By way of a non-limiting example, controls can:

Contain business logic users want to keep separate from other application code, or which may be reused.

Provide access to resources such as databases or other resources.

Collect logic that coordinates multiple actions, such as those that involve multiple database queries, calls to Enterprise JavaBeans (with the EJB control), and so on. A control can participate in the implicit transaction of a conversational container, such as a web service that is conversational.

In one embodiment, the IDE can provide several built-in controls, mostly designed to provide access to resources. By way of a non-limiting example, users can use a built-in EJB control for access to Enterprise JavaBeans®, a JMS control for access to the Java Message Service, and so on. Users can build their own controls that are based on the same framework on which built-in controls are based. Users can design a custom control from the ground up, designing its interface and business logic, adding other controls as needed. Users can design a custom control for use in one project, or users can design a custom control for easy reuse in multiple projects.

Built-in controls and custom controls that have been set up for use in multiple projects, can be displayed in the IDE's graphical user interface (GUI) (e.g., via a palette or a menu). By default, a control palette can be displayed which allows a user to add controls to a design by interacting with the palette (e.g., by dragging and dropping the control onto a work area).

When a control is in a user's design, its methods and callbacks can also displayed in a GUI. Users can also drag methods and callbacks onto a design canvas to create “pass-through” methods. A pass-through is a shortcut way to call a control's method from a user's current design.

In one embodiment, Users can use controls locally as source, or group them into control projects. A control is said to be local when its source files reside in the same project as the code that uses the control. Control projects provide a way to group related controls, and to package them for distribution among multiple projects. Users can create a control project just as users would other kinds of projects, then add files for their controls. In one embodiment, the result of a control project is can be JAR file users can distribute for use in any IDE application.

In one embodiment, controls can provide a static programmatic interface (e.g. API), some are customizable. In one embodiment, when users add a new customizable control to a project, the IDE can generate a JCX file that extends the control. In some cases, such as with a Database control or JMS control, users can customize the control by adding or editing methods defined in the JCX file.

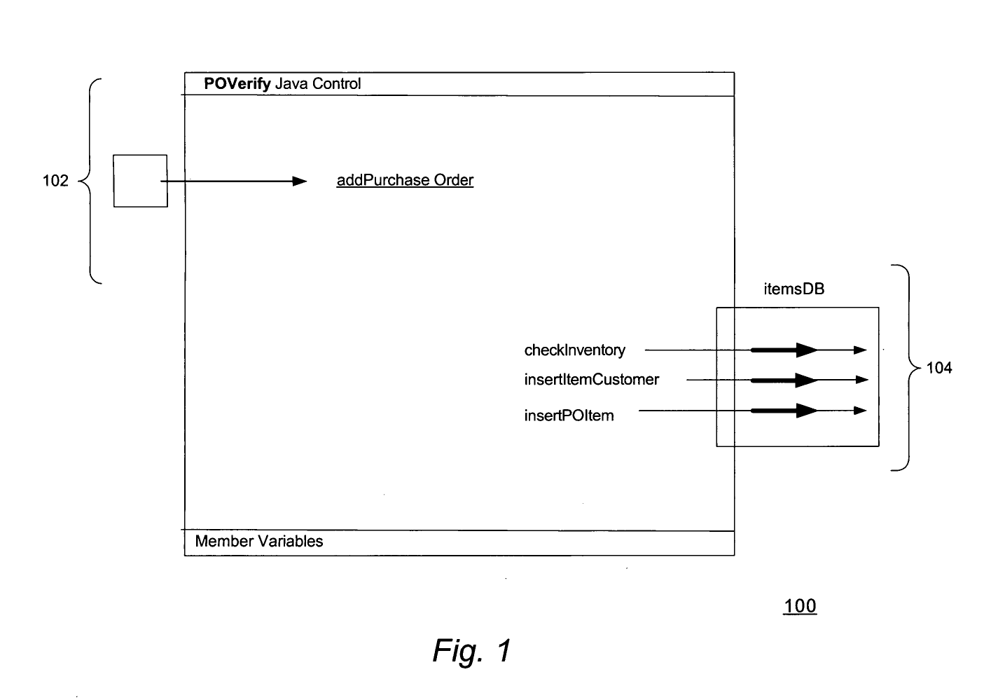

FIG. 1 is a illustration of an exemplary graphical representation of a control in an embodiment. After users create a control source (JCS) file in a language such as (but not limited to) Java®, a graphical canvas 100 can provide a space in which users can create a visual representation of their control's programmatic interface as well as the controls it may itself be using. The left side 102 can display operations that will be visible to the control's clients, while the right side 104 can display nested controls. In one embodiment, users can have easy access to a control's source file by double-clicking the graphical representation of the control.

When users add a new control source file to a project, the IDE can also add a file that contains the control's public interface. By default, as users work in the JCS file, adding methods, callbacks, and implementation code, the IDE keeps the interface in sync. By way of a non-limiting example, adding an operation to the JCS will also add a corresponding method to the JAVA file. In one embodiment, the JAVA file will be kept in sync only with respect to those methods with an @common:operation annotation. This means that if users add a method to the JCS, then remove its @common:operation annotation, the IDE will remove the method from the JAVA file.

In one embodiment, controls can expose properties. By way of a non-limiting example, the Database control provides properties that specify its database connection, log category name, and so on. Users can define properties by creating an annotation XML file that describes them. Users then associate the file with the control source code through the JCS file's control-tags property. When a developer is using the control, setting its properties, the settings are saved as annotations in the developer's code.

In one embodiment, users can define certain IDE characteristics for their Java control. These include the icon that represents it in palettes and menus (and whether it is displayed in the palette at all), its description in a Property Editor, and so on.

Once a control has been added to an application, users can invoke its methods using the standard Java dot notation (assuming the control was written in the Java programming language). By way of a non-limiting example, assume that the “CustomerDb” Java control is added to an application and a variable is declared for the control as “custDb”, and that the control defines a method as follows:

String [ ] getAllCustomerNames( )

In one embodiment, users can invoke this method from their application as follows:

String [ ] custNames;

custNames=custDb.getAllCustomerNames( );

In one embodiment, controls allow the specification of callbacks. Callbacks provide a way for a control or a web service to asynchronously notify a client that an event has occurred. A callback is a method signature that is defined by a resource like a control where the method implementation can be provided by the client. The client enables reception of a callback by implementing a callback handler.

In one embodiment, a callback definition in a Java control may look like the following:

void onReportStatus(String status);

In one embodiment, this declaration can appear in the source code for the service or control that defines the callback. There's no code associated with the callback definition—only the method signature, including the return type and any parameters. The name of this callback handler suggests that the handler will be invoked when the report status is provided by a client. The application is responsible for implementing the handler for a callback defined by a control. The following shows an example of a callback handler as it might appear in their application:

void exampleControl_onReportStatus(String status)

{

// add their code here to take appropriate action given

// the status of the report

}

In the IDE, callback handler names can be determined by the name of the control instance and the name of the callback. In the example above, the control instance from which we wish to receive the callback is exampleControl. The full name of the callback handler, exampleControl_onReportStatus, is the control instance name followed by an underscore and the name of the callback.

The designer of a Java® control may choose whether or not to explicitly declare that exceptions are thrown by the control's methods. If a control method is declared to throw exceptions, users can enclose their invocations of that method in a Java® try-catch block.

Even if the designer of the control chooses not to declare exceptions, the support code that implements the control can still throw exceptions. In one embodiment, the type of exception thrown is com.bea.control.Control Exception.

A built-in control can be used by a custom Java control to delegate subtasks, but it can also be used directly by a web service in much the same way. Built-in controls, as well as custom controls, can furthermore be invoked from a web page, although the procedure for invoking these controls from a web page environment is somewhat different.

When users add a built-in control to their application via the IDE, they are actually creating a new control file. In an Insert Control dialog, users can specify a name for the new control file that the IDE creates. By default the IDE can add this control file with a JCX extension to the same folder as the file that is currently open in a design view. When users add a control to their application, the IDE can modify their file's source code to include an annotation and variable declaration for the control. The annotation ensures that the control is recognized by the IDE, and the variable declaration gives users a way to work with the control from their code. By way of a non-limiting example, if users create a new Database control named CustomerDb in the customers folder in their project, and specify a variable name of custDb, the following code will be added to their file:

/* *

* @common:control

*/

private customers.CustomerDb cus

In one embodiment, files with the extension JCX are control extensions for controls written in Java®. They typically include a collection of method definitions that allow users to easily access a resource such as a database or another enterprise resource. In some cases, users may use an existing JCX file that was produced by another member of their team or another organization. By way of a non-limiting example, if many web services will use the same database, a single author might create a Database control extension (JCX file) that describes the interface to the database. Then multiple web service authors might use that JCX file to create a Database Control in their service and use it to access the common database. The same situation can occur for all of the control types.

Whenever users create a control while editing a web service or other container, the IDE generates a JCX file to contain a local representation of the control. The following are non-limiting examples of situations in which a JCX file will be generated:

When users create a new Database control: The IDE generates a new JCX file to hold the Database control extensions definition. When users add methods to the Database control via the IDE, users are adding methods to the JCX file.

When users add a Web Service control to access a web service based on the service's WSDL file: users can generate a Web Service control JCX file from the WSDL file, then use the new Web Service control from any control container.

A control factory allows a single application to manage an n-way relationship with a control. By way of a non-limiting example, an application can disassemble the line items of an incoming purchase order and conduct a concurrent conversation with a separate Web Service control for each of multiple vendors.

For any control interface called MyControl, a Server generates a control factory interface called MyControlFactory that has the following very simple shape:

interface MyControlFactory

{

MyControl create( );

}

In one embodiment, an implicit factory class can be located in the same package as the control class; that is, if the full class name of the control interface is com.myco.mypackage.MyControl, then the full class name of the factory is com.myco.mypackage.MyControlFactory. An automatic factory class is not generated if there is a name conflict (i.e., if there is already an explicit user class called MyControlFactory.)

A control factory instance can be included in a file just as a control instance can, with the same Javadoc annotation preceding the factory declaration that would precede a single control declaration.

By way of a non-limiting example, an ordinary Web Service control can be declared as follows:

/**

* @common:control

*/

MyServiceControl oneService;

A Web Service control factory can be declared as follows:

/**

* @common:control

*/

MyServiceControlFactory manyservices;

Note again that the set of annotations on a factory are exactly the same as the set of annotations on the corresponding control. The factory behaves as if those annotations were on every instance created by the factory.

Once an application includes a control factory declaration, a new instance of a single control can be created as follows:

// creates one control MyServiceControl c=manyservices.create( );

// then users can just use the control or store it c.someMethod( );

// For example, associate a name with the service serviceMap.put(“First Service”, c);

In one embodiment, factory classes can automatically generated on-demand, as follows. When resolving a class named FooFactory:

First the class is resolved normally. By way of a non-limiting example, if there is a CLASS file or JAVA file or JCX file that contains a definition for FooFactory, then the explicitly defined class is used.

If there is no explicit class FooFactory, then, since the classname ends in “Factory”, we remove the suffix and look for an explicit class called Foo (in the same package).

If Foo is found but does not implement the Control interface (i.e., is not annotated with @common:control), it's considered an error (as if Foo were never found).

However, if Foo is found and implements the Control interface, then the interface FooFactory is automatically created; the interface contains only the single create( ) method that returns the Foo class.

Since there may be multiple controls that were created with a single control factory, and they all have the same instance name, a mechanism can be provided to enable users to tell which instance of the control is sending a callback. By way of a non-limiting example, for the oneService example above, an event handler still has the following form:

void oneService_onSomeCallback(String arg)

{

System.out.println(“arg is”+arg);

}

For callback handlers that are receiving callbacks from factory-created control instances, the callback handler can take an extra first parameter that is in addition to the ordinary parameters of the callback. The first parameter is typed as the control interface, and the control instance is passed to the event handler. In one embodiment, the manyServices factory callback handler looks like this:

void manyServices_onSomeCallback(

MyServiceControl C, String arg)

{

// let's retrieve the remembered name

// associated with the control

String serviceName=(String)serviceMap.get(c);

// and print it out

System.out.println(

“Event received from”+serviceName);

}

A custom control can be invoked by other custom controls or by a web service using the procedures described here. A custom control can also be invoked from a web page, although the procedure for invoking the control from a web page environment is somewhat different.

In one embodiment, the IDE creates the JCS file for a new custom control and displays it a Design View. It also creates a JAVA file without the “Impl” ending for their control's public interface. As users build their control, users work in the JCS file, adding code for the control's logic. The IDE updates the JAVA file code to reflect changes to the control's public interface as the user makes said changes. In other words, users never have to edit the JAVA file manually.

In one embodiment, if users have access to a custom Java control that they implemented or that was implemented by another developer, they can add it to a web service or another custom Java control. Users have access to a control if users have access to its JCS file in their project. If the control is not in their project, users can copy it to their project. If the JCS file and the associated Java file for the custom control users wish to use is not in their project, users can copy it to their project directory.

In one embodiment, when users add a control to their application, the IDE modifies their file's source code to include an annotation and variable declaration for the control. The annotation ensures that the control is recognized by the IDE, and the variable declaration gives users a way to work with the control from their code. By way of a non-limiting example, if users create a new custom control named Subscriptions in the CustomerControls folder in their project, and specify the variable name subscription, the following code will be added to their file:

/ * *

* @common:control

*/

private CustomerControls.Subscriptions subscriptions;

At their most basic, Controls users develop include a Java control source (JCS) file. Users can also add properties to the control by including an annotation XML file. A Java control source (JCS) file contains the control's logic-the code that defines what the control does. In this file users define what each of the control's methods do. Users can also define how control property values set by a developer influence the control's behavior, as in the following example.

In one embodiment, when users add a new Java control source file to a project, the IDE also adds a JAVA file that contains the control's public interface. Under most circumstances, users should not edit this file. By default, as users work in the JCS file, adding methods, callbacks, and implementation code, the IDE keeps the interface in sync. By way of a non-limiting example, adding an operation to the JCS will also add a corresponding method to the JAVA file. Note that the JAVA file will be kept in sync only with respect to those methods with an @common:operation annotation. This means that if users add a method to the JCS, then remove it's @common:operation annotation, the IDE will remove the method from the JAVA file.

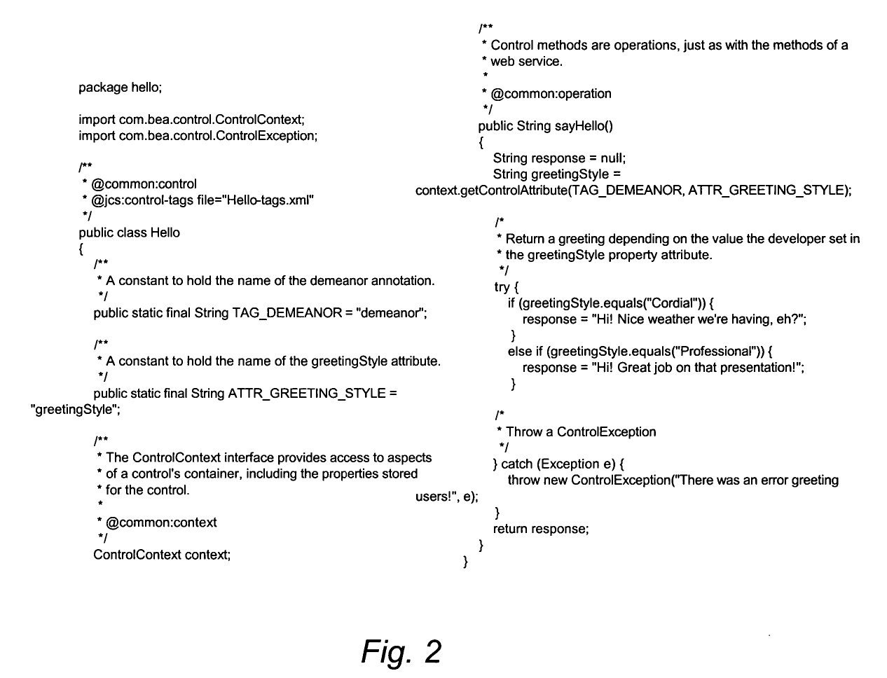

FIG. 2 is an exemplary Java control source (JCS) file in an embodiment of the invention. A control implementation class Hello contains the logic for a control. The @common:control annotation tells the IDE to create and maintain this control's interface. This removes the necessity for users to do so. The control-tags annotation @jcs:control-tags associates this control source file with the annotation XML file “Hello-tags.xml” that describes the properties it exposes. The ControlContext interface provides access to aspects of a control's container, including the properties stored for the control. Control methods are operations, just as with the methods of a web service.

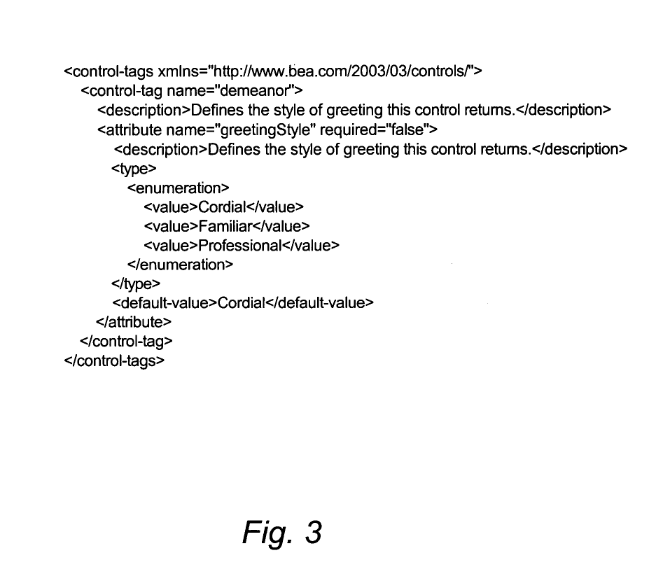

FIG. 3 is an exemplary control property definition file in an embodiment of the invention. The property definition file is an annotation XML file that defines the properties a control exposes, including their data types. Users can create a property definition file based on a particular schema. This figure illustrates how users might define the properties for the preceding Hello control. The property characteristics specified in this example include: one property for the control—demeanor—and one attribute for that property—greetingStyle. The greetingStyle attribute takes one of three enumerated values.

Portal Controls are used to build applications. They allow users to leverage portal functions more rapidly in application development. Like the built-in controls included with the IDE, Portal Controls enable users to insert well-implemented functionality into their portlets without doing lots of their own coding. Portal-specific controls provide reusable solutions to problems portal developers often face.

In one embodiment, three types of controls area available to any instance of portal built from the portal template; Personalization Controls, Portal Event Controls and Portal EJB Controls. Portal controls can be used to expose tracking and personalization functions in multi-page portlets. For instance, to enable users to register, login and edit their properties, users could use a Page Flow portlet, use the design view to insert a combination of the User Management controls with a form control, set a few properties and view the portlet immediately.

Portal Controls are designed for use within Page Flows, where the Page Flow handles navigation logic and the Portal Control encapsulates tracking and personalization functionality.

In one embodiment, a Click Content Event Control can provide a simple way to dispatch events involving content display from within a Page Flow. After this control is added to a Page Flow, this dispatch action can be exposed in a portlet, and then a GUI element such as a Button can be used to invoke the dispatch action. This control is used to handle the following two variables: Document Type and Document ID. The Session and Request objects maybe obtained from a Page Flow as follows:

HttpServletRequest request=this.getRequest( );

Each control can be configured with annotations, to parameterize the control. The configuration XML file has a well-defined schema that can declare:

Default values for attributes

Whether the attributes are required when the control is declared

Where the attributes may be specified (e.g., on method, on control declaration)

A resourceType property specifies whether the resource is one of the following types:

GlobalRoleResource

EnterpriseRoleResource

WebappRoleResource

HierarchyRoleResource

LeafRoleResource

In one embodiment, a Create User Control can be used by portal interface components (such as the Form control) to create a user and return an object representing the user's information.. Using the Form control to submit fields to this control from a Page Flow, users can create a new user from within a portlet. The results can be displayed if user creation was successful, or by displaying an error message if it fails.

In one embodiment, a Display Content Event Control dispatches a ‘DisplayContentEvent’ to a Portal Behavior Tracking System. Session and Request objects maybe obtained from a Page Flow by:

HttpServletRequest request=this.getRequest( );

In one embodiment, a Generic Tracking Control is used to expose the configuration, generation and dispatch of behavior tracking events in a portlet. The eventType is set as a property on the control via an annotation. Once users have an Event object, they may set its attributes:

event.setAttribute (String theKey, Serializable thevalue);

In one embodiment, the Rule Event Control dispatches a RuleEvent to the Portal Behavior Tracking System. This control can dispatch a login event to the Portal Behavior Tracking System. This control can be placed inside a Page Flow if users want to fire a session event from within a specific portlet. The Request object may be obtained from a Page Flow using the following code:

HttpServletRequest request=this.getRequest( );

In one embodiment, a Session Login Event Control can dispatch a ‘sessionLoginEvent’ to the Portal Behavior Tracking System. This control can be placed inside a Page Flow if users want to fire a session event from within a specific portlet.

In one embodiment, a User Login Control can be placed on a Page Flow action allows a user to login using a portlet. A form component sends authentication information to the UserLogin control. If the login is successful, access to user profile information is granted. If not, an exception is thrown. This control can be used by the portal GUI components to send authentication information to the portal site. It allows a site visitor to log in to the portal, and gives indication as to whether the login is successful. The control also provides access to the user's profile information, if the login successful.

In one embodiment, a User Profile Control can expose user profile information to a Page Flow portlet. This is useful if users need to get all properties for a user, or only a subset of properties. Obviously, in order to obtain access to this information, a user would need to login with appropriate privileges. For this reason, a Page Flow that uses the User Profile Control would be a good candidate for a nested page flow. In one embodiment, this control is backed by the UserManager EJB, which can deployed into every Portal application created in the IDE.

In one embodiment, a User Registration Event Control can be used to dispatch a ‘UserRegistrationEvent’ to the Portal Behavior Tracking System. The Request object may be obtained from a Page Flow by:

HttpServletRequest request=this.getRequest( );

In one embodiment, a User Information Query Control can be used to return a list of roles for a particular user and also the list of immediate parent groups. It can also return the list of groups to which that user belongs.

In one embodiment, an Event Service Control can be put into a Page Flow and passed events that will be handled by registered listeners. Listeners can register themselves for this service via the management console; classes that implement the EventListener interface may add themselves as listeners using the Configuration tab for the Event Service. Those classes express interest in certain Event types, and when an event of that is dispatched via this service, it is forwarded to the listener. This control interacts with the EventService EJB, which can be deployed to the application.

In one embodiment, , a User Profile Control can expose the user profile information to a Page Flow portlet. This is useful if users need to get all properties for a user, or only a subset of properties. Obviously, in order to obtain access to this information, a user would need to login with appropriate privileges. For this reason, a Page Flow that uses the User Profile Control would be a good candidate for a nested page flow.

Although several examples of portal controls were provided herein, it will be apparent to those of skill in the art that many such more controls are within the scope and spirit of this disclosure.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method for providing a reusable software control, comprising:
incorporating the control into an Integrated Development Environment (IDE), wherein a graphical representation of the control can be interactively manipulated;
exposing services associated with the control and related to programmatically interacting with a portal; and
wherein the control has a customizable interface.

2. The method of claim 1 wherein the services can include:
a first group of services related to portal tracking; and
a second group of services related to portal personalization.

3. The method of claim 1 wherein the interactive manipulation of the control includes:
graphically connecting the control to other controls to establish flow-of-control at run-time.

4. The method of claim 1 wherein:
the control includes annotated Java code.

5. The method of claim 1 wherein:
the control can use other controls.

6. The method of claim 1, further comprising:
specifying IDE characteristics of the control.

7. The method of claim 1 wherein:
the services related to interacting with a portal can include one or more of: portal personalization, portal events and portal configuration.

8. A method for providing a reusable software control, comprising:
incorporating the control into an Integrated Development Environment (IDE), wherein a graphical representation of the control can be interactively manipulated by graphically connecting the control to other controls to establish flow-of-control at run-time;
exposing services associated with the control and related to programmatically interacting with a portal; and
wherein the control has a customizable interface.

9. The method of claim 8 wherein the services can include:
a first group of services related to portal tracking; and
a second group of services related to portal personalization.

10. The method of claim 8 wherein:
the control includes annotated Java code.

11. The method of claim 8 wherein:
the control can use other controls.

12. The method of claim 8, further comprising:
specifying IDE characteristics of the control.

13. The method of claim 8 wherein:
the services related to interacting with a portal can include one or more of: portal personalization, portal events and portal configuration.

14. A framework for providing a reusable software control, said framework comprising:
an Integrated Development Environment (IDE) operable to incorporate the control, wherein a graphical representation of the control can be interactively manipulated in the IDE;
a set of services associated with the control and related to programmatically interacting with a portal; and
wherein the control has a customizable interface.

15. The system of claim 14 wherein the services can include:
a first group of services related to portal tracking; and
a second group of services related to portal personalization.

16. The system of claim 14 wherein the interactive manipulation of the control includes:
graphically connecting the control to other controls to establish flow-of-control at run-time.

17. The system of claim 14 wherein:
the control includes annotated Java code.

18. The system of claim 14 wherein:
the control can use other controls.

19. The system of claim 14, further comprising:
specifying IDE characteristics of the control.

20. The system of claim 14 wherein:
the services related to interacting with a portal can include one or more of: portal personalization, portal events and portal configuration.

21. A framework for providing a reusable software control, said framework comprising:
an Integrated Development Environment (IDE) operable to incorporate the control, wherein a graphical representation of the control can be interactively manipulated in the IDE by graphically connecting the control to other controls to establish flow-of-control at run-time;
a set of services associated with the control and related to programmatically interacting with a portal; and
wherein the control has a customizable interface.

22. The system of claim 21 wherein the services can include:
a first group of services related to portal tracking; and
a second group of services related to portal personalization.

23. The system of claim 21 wherein the interactive manipulation of the control includes:
graphically connecting the control to other controls to establish flow-of-control at run-time.

24. The system of claim 21 wherein:
the control includes annotated Java code.

25. The system of claim 21 wherein:
the control can use other controls.

26. The system of claim 21, further comprising:
specifying IDE characteristics of the control.

27. The system of claim 21 wherein:
the services related to interacting with a portal can include one or more of: portal personalization, portal events and portal configuration.

28. A machine readable medium having instructions stored thereon that when executed by a processor cause a system to:
incorporate control into an Integrated Development Environment (IDE), wherein a graphical representation of the control can be interactively manipulated;
expose services associated with the control and related to programmatically interacting with a portal; and
wherein the control has a customizable interface.

29. The machine readable medium of claim 28 wherein the services can include:
a first group of services related to portal tracking; and
a second group of services related to portal personalization.

30. The machine readable medium of claim 28 wherein the interactive manipulation of the control includes:
graphically connecting the control to other controls to establish flow-of-control at run-time.

31. The machine readable medium of claim 28 wherein:
the control includes annotated Java code.

32. The machine readable medium of claim 28 wherein:
the control can use other controls.

33. The machine readable medium of claim 28, further comprising instructions that when executed cause the system to:
specify IDE characteristics of the control.

34. The machine readable medium of claim 28 wherein:
the services related to interacting with a portal can include one or more of: portal personalization, portal events and portal configuration.

35. A computer data signal embodied in a transmission medium, comprising:
a code segment including instructions to incorporate control into an Integrated Development Environment (IDE), wherein a graphical representation of the control can be interactively manipulated;
a code segment including instructions to expose services associated with the control and related to programmatically interacting with a portal; and
wherein the control has a customizable interface.
